(19) United States
(12) Patent Application Publication
(10) Pub. No.: US 2011/0148724 A1
(43) Pub. Date: Jun. 23, 2011

(54) ANTENNA DEVICE

(75) Inventor: Kenji Ogawa, Kanagawa (JP)

(73) Assignee: Panasonic Corporation, Kadoma-shi, OSAKA (JP)

(21) Appl. No.: 13/059,625

(22) PCT Filed: Aug. 11, 2009
(86) PCT No.: PCT/JP2009/003865

§ 371 Date: Feb. 17, 2011

(30) Foreign Application Priority Data
Aug. 29, 2008 (JP) 2008-221598

(51) Int. Cl. H01Q 13/18; H01Q 9/06

(52) U.S. Cl. 343/767; 343/843

(57) ABSTRACT

Disclosed is an antenna device that achieves greater reduction in size and a wider bandwidth. The antenna device has a box-type antenna element (102) and a folded-back monopole element (107), which are connected. The device is grounded via a grounding terminal (103) at one apex of the box-type antenna element (102), and is also connected to an electricity supply unit (106) of a substrate (101) via a feed terminal (105) at the apex which forms a long side with the grounded apex. In addition, the length from the grounding point (104) of the box-type antenna element (102) to the tip of the monopole element (107) is set to one-quarter the wavelength of a first resonant frequency, and the length from the electricity supply unit (106) to the tip of the monopole element (107) is set to one-quarter the wavelength of a second resonant frequency.

### TECHNICAL FIELD

The present invention relates to an antenna apparatus to support a plurality of frequency bands.

### BACKGROUND ART

For a wireless communication terminal apparatus typified by a mobile telephone (hereinafter “terminal”), there is a demand to have higher functions and there is also a demand for miniaturization, so as to be applicable to multiple wireless communication systems. To meet these demands, an antenna to be incorporated in a terminal is also required to have a wide-band characteristic and be miniaturized to support multiple wireless communication systems. Patent literature 1 and patent literature 2 disclose antennas of this kind.

FIG. 1 shows the antenna configuration disclosed in patent literature 1. This antenna has first element 10 having an electrical length of a ¼ wavelength of the first oscillation frequency, and second element 11 that oscillates at a second oscillation frequency. By placing first element 10 close to second element 11 in a position approximately a ⅓ wavelength of the first oscillation frequency from power feed section 12 and by capacitive-coupling these, the antenna oscillates at a third oscillation frequency that is not an integral multiple of the first oscillation frequency.

FIG. 2 shows the antenna configuration disclosed in patent literature 2. This is an antenna that enables multi-oscillation and impedance adjustment and that is easy to incorporate in a wireless apparatus, and power is fed to folded, monopole-type first antenna element 20 and open-ended, monopole-type second antenna element 21. A short-circuit point (ground point 22) is provided in the middle of first antenna element 20, and the combined length of the outbound path, which is from power feed point 23 to the folding point, and the inbound path, which is to ground point 22, is a ½ wavelength of the oscillation frequency. Second antenna element 21 diverges between power feed point 23 and ground point 22, making the entire element length approximately a ¼ wavelength of the oscillation frequency and allowing first antenna element 20 to function as a stub of second antenna element 21.

### CITATION LIST

### Patent Literature

### PTL 1

Japanese Patent Application Laid-Open No. 2007-036338

### PTL 2

Japanese Patent Application Laid-Open No. 2005-196994

### SUMMARY OF INVENTION

### Technical Problem

However, with the antenna disclosed in patent literature 1 described above, the second element that oscillates at a second oscillation frequency requires a new mounting space apart from that of the first element, and therefore the first element has to be made thin and linear and further band-broadening and miniaturization become difficult.

Also, with the antenna disclosed in patent literature 2 described above, due to the fact that the first antenna element has a complex structure, it is difficult to increase the width of elements, and, consequently, further band-broadening and miniaturization are difficult.

It is therefore an object of the present invention to provide an antenna apparatus to allow further miniaturization and band-broadening.

### Solution to Problem

An antenna apparatus according to the present invention employs a configuration having: a box-shaped antenna element having a cuboid shape; a ground point to be connected with a vertex of the box-shaped antenna element; a power feed point to be connected with a vertex forming a same side with the vertex connected with the ground point; and a monopole element to be connected to a vertex that is diagonal to the vertex connected with the ground point in the same plane, having a ¼ wavelength of a first oscillation frequency as a length from the ground point to an open-ended tip, having a ¼ wavelength of a second oscillation frequency higher than the first oscillation frequency as the length from the power feed point to the tip, and being folded back to form a side of a cuboid.

### Advantageous Effects of Invention

The present invention allows further miniaturization and band-broadening of an antenna apparatus.

### BRIEF DESCRIPTION OF DRAWINGS

FIG. 1 shows an antenna configuration disclosed in patent literature 1;

FIG. 2 shows an antenna configuration disclosed in patent literature 2;

FIG. 3 is a perspective view showing an antenna apparatus configuration according to embodiment 1 of the present invention;

FIG. 4 illustrates a case where a monopole antenna is meander-shaped;

FIG. 5 illustrates a case where a slot is provided in a box-shaped antenna element;

FIG. 6 illustrates a case where a meander-shaped slot is provided in a box-shaped antenna element;

FIG. 7 illustrates a case where corners of a box-shaped antenna element are made planar;

FIG. 8 illustrates a case where an element that diverges in the middle of the inbound path of a monopole element;

FIG. 9 is a perspective view showing an antenna apparatus configuration according to embodiment 2 of the present invention; and

FIG. 10 shows a VSWR characteristic of an antenna apparatus according to embodiment 2 of the present invention.

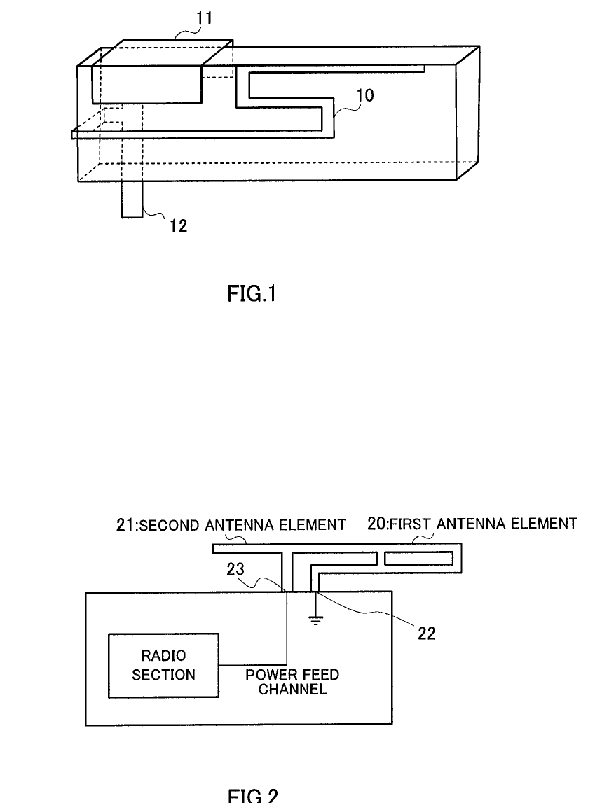

### DESCRIPTION OF EMBODIMENTS

Now, embodiments of the present invention will be described below in detail with reference to the accompanying drawings. However, in the embodiments, parts having the same functions will be assigned the same codes and overlapping descriptions will be omitted.

### Embodiment 1

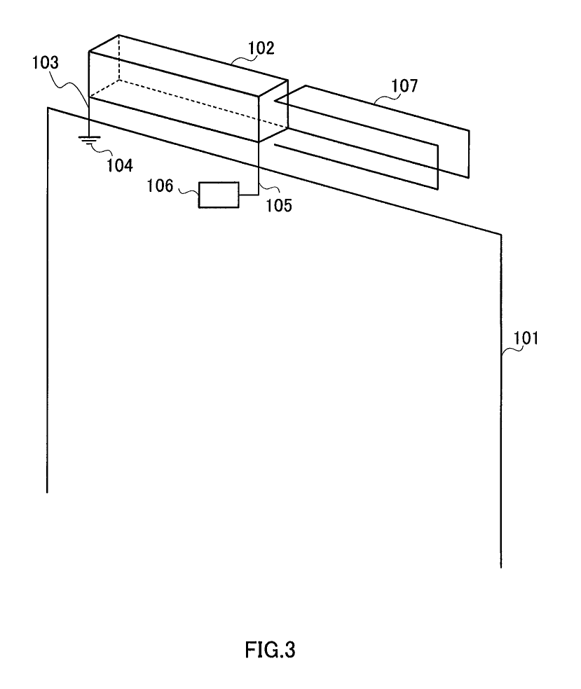

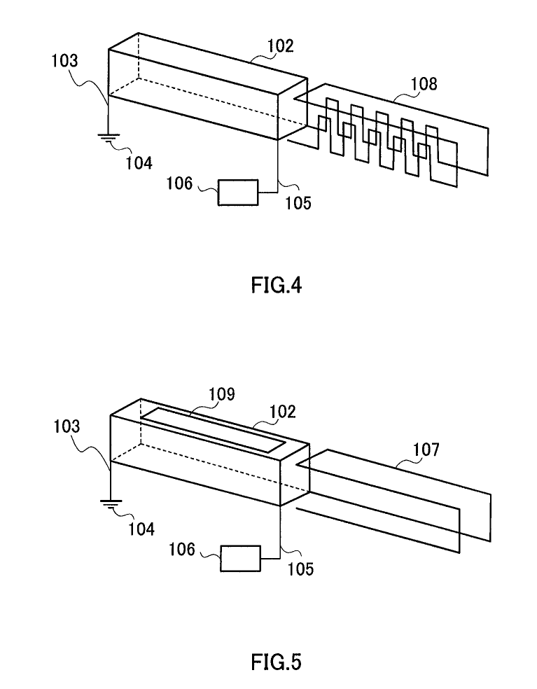

FIG. 3 is a perspective view showing an antenna apparatus configuration according to embodiment 1 of the present invention. As shown in this figure, an antenna element is provided in one short side of substrate 101 having a rectangular shape. The antenna element has box-shaped antenna element 103 and monopole element 107.

Box-shaped antenna element 102 has a shape of a cuboid with a length of 22 mm, a height of 8 mm, and a width of 5 mm, and, assuming that the plane to face substrate 101 is the bottom plane, amongst the vertices to define the bottom plane, a vertex close to a vertex of substrate 101 is grounded to a ground section of substrate 101 via ground terminal 103 (ground point 104). The vertex forming the same long side with the grounded vertex of box-shaped antenna element 102, is connected to power feed section 106 of substrate 101 via power feed terminal 105. Furthermore, monopole element 107 is connected to the vertex diagonal to the grounded vertex in the bottom plane.

Monopole element 107 has its one end connected to the vertex diagonal to the grounded vertex in the bottom plane of box-shaped antenna element 102, and is folded back so as to form sides of a cuboid having the same size as box-shaped antenna element 102 and arranged in the long-side direction of box-shaped antenna element 102. The tip of monopole element 107 is open-ended.

The length from ground point 104 of box-shaped antenna element 102 to the tip of monopole antenna element 107 is set a ¼ wavelength of the first oscillation frequency, and the length from power feed section 106 to the tip of monopole element 107 is set a ¼ wavelength of a second oscillation frequency.

Next, the principle of operation of the above-described antenna apparatus will be described. Here, the first oscillation frequency is 824 MHz and the second oscillation frequency is 2690 MHz. In the first oscillation frequency, current flows in the tip of monopole element 107, box-shaped antenna element 102, and ground terminal 103, in order, and current is concentrated particularly in box-shaped antenna element 102. In the antenna apparatus configuration described above, the path from the tip of monopole element 107, via box-shaped antenna element 102, to ground point 104, is approximately 108 mm, and the antenna element oscillates as an element of a ¼ wavelength of the 800 MHz band. Thus, although the antenna element oscillates with a ¼ wavelength in the 800 MHz band, but current is then concentrated in the root of box-shaped antenna element 102. Given that current is concentrated in box-shaped antenna element 102 which can secure a wide area as a current distribution range, band-broadening in the lower frequency band is made possible.

On the other hand, in the second oscillation frequency, the current from power feed terminal 105 to monopole element 107 is predominant, and therefore little current flows in box-shaped antenna element 102. Because the gap between power feed terminal 105 and ground terminal 103 functions as a ¼ wavelength short-circuit stub for the 2.6 GHz, current does not flow in box-shaped antenna element 102, and only in monopole element 107 does current flow easily. By this means, band-broadening in the higher frequency band is made possible.

Thus, according to embodiment 1, with an antenna apparatus to which a box-shaped antenna element and a monopole element are connected, the length from a ground point of the box-shaped antenna element to the tip of the monopole element is set a ¼ wavelength of the first oscillation frequency and the length from a power feed point to the tip of the monopole element is set a ¼ wavelength of a second oscillation frequency, so that a plurality of frequency bands can be broadened each and the miniaturization of an antenna cane be realized.

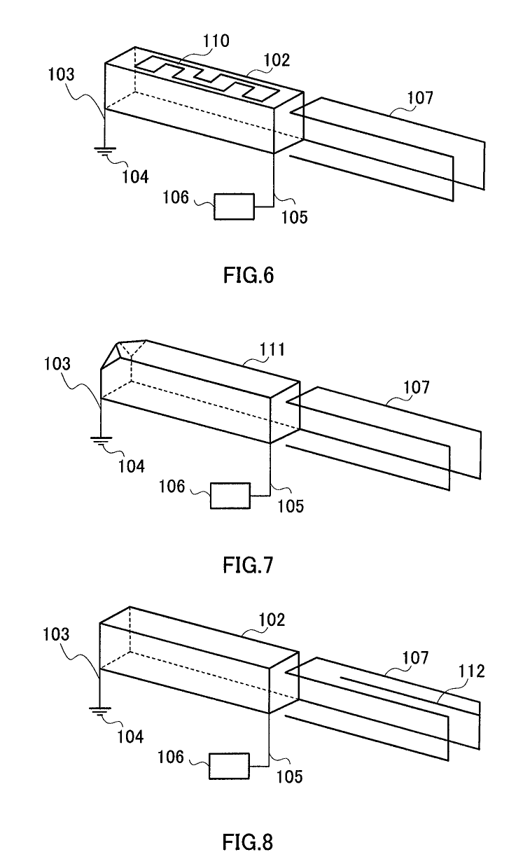

Furthermore, an antenna can be made even smaller by making monopole element 108 a meander shape. Also, as shown in FIG. 5, further multi-oscillation is possible by providing slot 109 of a ½ wavelength of a third oscillation frequency in box-shaped antenna element 102. Also, as shown in FIG. 6, multi-oscillation and miniaturization are possible by making slot 110 to be provided in box-shaped antenna element 102 a meander shape. Slots 109 and 110 can be provided in any plane of box-shaped antenna element 102.

It is possible, as shown in FIG. 7, to cut off and make planar the corners of box-shaped antenna element 111 or make the corner of the box-shaped antenna element round. By this means, it is possible to design an antenna to fit the shape of the terminal casing.

Furthermore, it is also possible, as shown in FIG. 8, to provide element 112 that diverges in the middle of the inbound path of monopole element 107. By this means, further multi-oscillation is possible.

### Embodiment 2

Although a case has been described with embodiment 1 where the monopole element is linear, a case will be described with embodiment 2 where the monopole element is flat.

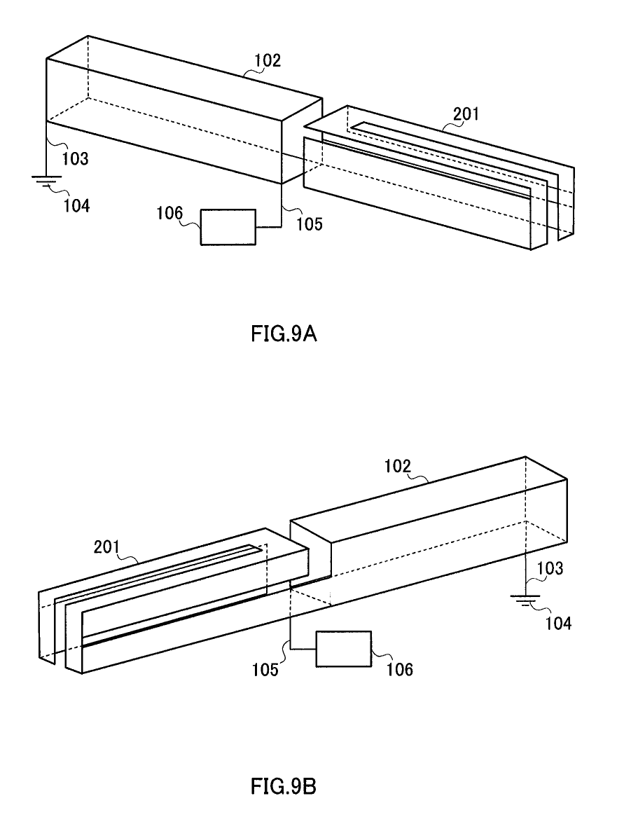

FIG. 9 is a perspective view showing a configuration of an antenna apparatus according to embodiment 2 of the present invention. FIG. 9A is a perspective view seen from the front, and FIG. 9B is a perspective view seen from the opposite side. In these figures, monopole element 201 has a flat shape, has its one end connected to the vertex diagonal to the grounded vertex in the bottom plane of box-shaped antenna element 102, and is folded back so as to form sides of a cuboid having the same size as box-shaped antenna element 102 and arranged in the long-side direction of box-shaped antenna element 102. The tip of monopole element 201 is open-ended.

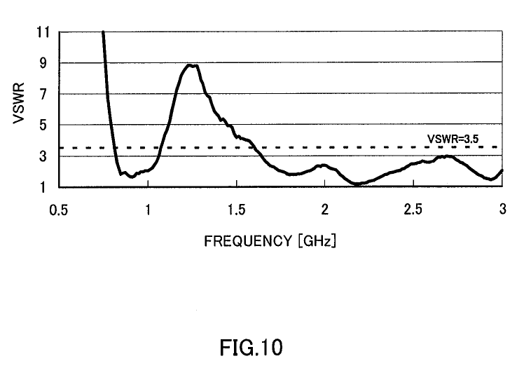

FIG. 10 shows a VSWR characteristic of an antenna apparatus according to embodiment 2 of the present invention. As shown in FIG. 10, the frequency bands to be “VSWR≦3.5” are 0.8˜1.1 GHz and 1.6˜2.7 GHz, so that both the lower frequency band and the higher frequency band can be broadened.

Thus, according to embodiment 2, especially the higher frequency band can be broadened by making the monopole element flat.

Upon mounting in a terminal, the above-described box-shaped antenna element is applicable to, for example, a metal component (for example, hinge metal of a folded terminal) having a conductor of substantially the same surface area as the box-shaped antenna element assumed.

The disclosure of Japanese Patent Application No. 2008-221598, filed on Aug. 29, 2008, including the specification, drawings and abstract, is incorporated herein by reference in its entirety.

### INDUSTRIAL APPLICABILITY

The antenna apparatus according to the present invention is applicable to wireless communication terminal apparatuses such as mobile telephones.

1. An antenna apparatus comprising:
a box-shaped antenna element having a cuboid shape;
a ground point to be connected with a vertex of the box-shaped antenna element;
a power feed point to be connected with a vertex forming a same side with the vertex connected with the ground point; and
a monopole element to be connected to a vertex that is diagonal to the vertex connected with the ground point in the same plane, having a ¼ wavelength of a first oscillation frequency as a length from the ground point to an open-ended tip, having a ¼ wavelength of a second oscillation frequency higher than the first oscillation frequency as the length from the power feed point to the tip, and being folded back to form a side of a cuboid.

2. The antenna apparatus according to claim 1 wherein the monopole element has a flat shape.

3. The antenna apparatus according to claim 1 wherein the monopole element has a meander shape.

4. The antenna apparatus according to claim 1, wherein the box-shaped antenna element has a slot in one plane.

5. The antenna apparatus according to claim 4, wherein the slot has a meander shape.

6. The antenna apparatus according to claim 1, wherein a corner of the box-shaped antenna element has a round shape or a planar shape.

7. The antenna element according to claim 1, wherein an element to diverge is provided in the middle of the monopole antenna.
